(19) United States
(12) Patent Application Publication
(10) Pub. No.: US 2009/0224862 A1
(43) Pub. Date: Sep. 10, 2009

(54) MAGNETIC APPARATUS AND METHOD

(75) Inventors: Vladimir Mikheev, Oxfordshire (GB); Paul Geoffrey Noonan, Oxfordshire (GB)

Correspondence Address: BLANK ROME LLP, WATERGATE, 600 NEW HAMPSHIRE AVENUE, N.W., WASHINGTON, DC, 20037, US

(73) Assignee: Oxford Instruments Superconductivity Ltd. a British company of Tubney Woods: Abingdon, Oxon (GB)

(21) Appl. No.: 11/721,107

(22) PCT Filed: Dec. 2, 2005
(86) PCT No.: PCT/GB05/04632

§ 371 Date: Jun. 7, 2007

(30) Foreign Application Priority Data
Dec. 7, 2004 (GB) 0426838.9

(51) Int. Cl. H01F 6/04

(52) U.S. Cl. 335/216

(57) ABSTRACT

Magnet apparatus (2) is provided comprising a magnet chamber (20), a magnet (2) positioned within the magnet chamber (20) and a quantity of superfluid coolant (30) which partially fills the magnet chamber (20) such that at least part of the magnet (2) is cooled by a superfluids film (31) of the coolant.

The present invention relates to a magnetic apparatus and method, for example for use in the cooling of high power magnets at cryogenic temperatures.

High field superconductivity magnets, for example for use in nuclear magnetic resonance (NMR) applications are often “sub-cooled” to a temperature a few Kelvin below the atmospheric boiling point of the liquid ⁴He (4.2K) coolant to improve the critical current capacity of the superconductor and allow a higher magnetic field to be generated. This is commonly achieved using a “lambda point refrigerator” to cool a bath of liquid ⁴He in which the magnet is submerged. The magnet bath is commonly sub-cooled to about 2.2K, which is just above the superfluid transition temperature (lambda or λ point) of ⁴He:T_{λ}=2.17K.

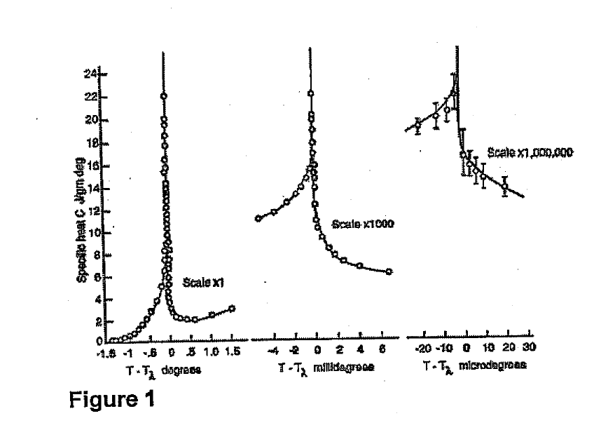

An operating temperature of 2.2K is preferred because the specific heat capacity of ⁴He peaks at the λ point, so it is desirable to operate as near the lambda point as possible to improve the temperature stability of the system. FIG. 1 shows a graph of specific heat capacity against deviation from lambda point for ⁴He on three scales of magnification.

It is generally considered undesirable to operate below the λ point. This is because below the λ point, a proportion of the helium coolant becomes a superfluid, with zero viscosity, and it will flow, even against gravity, in bulk liquid or through the smallest cracks and orifices towards areas of the cryostat at higher temperature, thus causing a large heat leak and increasing boil-off (the so-called “superleak” phenomenon). Fluid communication channels; such as quench valves become “superleak” paths if the magnet bath is cooled below the lambda point.

In early sub-cooled systems the magnet chamber was simply pumped to a low pressure, hence gradually evaporating the liquid bath and sub-cooling the magnet. With this simple design it is necessary to warm up the system, and hence de-energise the magnet, when the bath needs re-filling. To avoid this major cost and inconvenience, the lambda point refrigerator was invented.

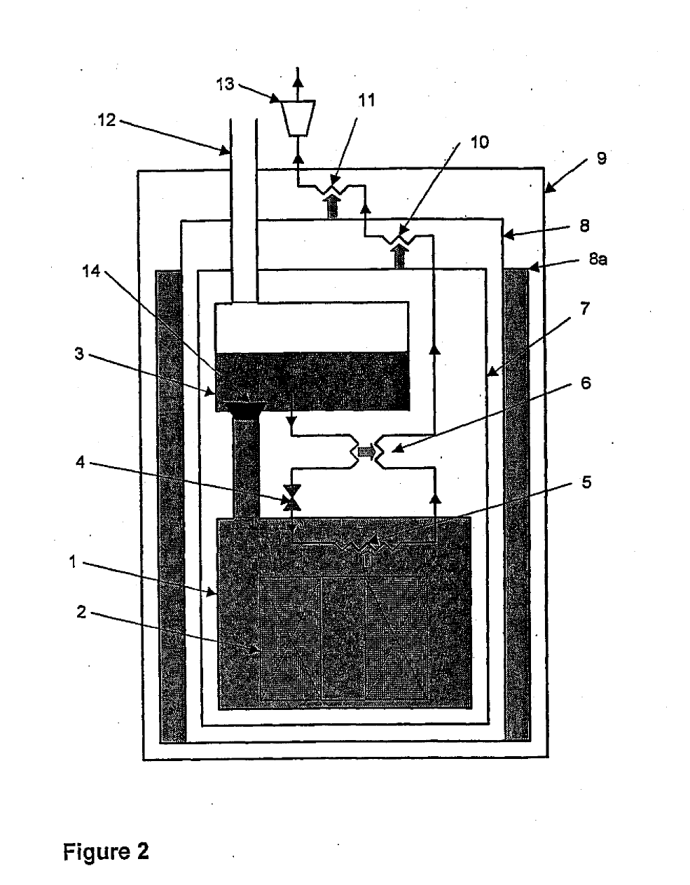

Referring now to FIG. 2, a typical prior art system is shown, cooled using a lambda point refrigerator. A superconducting magnet 2 is submerged in liquid ⁴He in a first vessel 1 at atmospheric pressure. A second vessel 3, which is open to atmosphere, holds a reservoir of liquid helium boiling at 4.2K; this reservoir may be refilled at any time through a tube 12. Liquid is conveyed from the second vessel 3 to a heat exchanger 5 in the first vessel via an (optional) second heat exchanger 6 and an expansion valve 4. The heat exchanger 5 is typically a coiled loop tube immersed in the top of the liquid helium bath of the second vessel. The pressure in the loop 5, on the downstream side of the valve 4, is reduced by pumping using an external pump 13, typically to 20-50 mbar. Helium liquid passing through the valve is partially vaporized and cooled by a few Kelvin due to the pressure drop across the valve 4. The reduced vapour pressure in the loop lowers the boiling temperature of the remaining liquid, which consequently evaporates, absorbing heat from the magnet bath and cooling it via heat exchange through 5. The vapour leaving the loop 5 is (optionally) passed through a second heat exchanger 6, which pre-cools the liquid entering the valve with the aim of reducing the fraction vaporized in the valve, and hence reducing the mass flow rate required for a given cooling power.

Note that the cooling power of the lambda point refrigerator is given by:

$$\frac{d Q}{d t} = ( 1 - γ ) \cdot \frac{d m}{d t} \cdot ( {H}_{vap} - {H}_{liq} )$$

where dm/dt is the total mass flow rate, H is enthalpy and γ is the fraction of liquid flashed to vapour in the valve.

The cold vapour leaving the second heat exchanger 6 passes up the neck of the cryostat within which the magnet apparatus is contained, through another heat exchanger 10, absorbing heat from a gas-cooled shield 7, which sits at a temperature at about 40K, and then through a final heat exchanger 11, absorbing heat from a second shield 8. The shields reduce the radiation heat load on the helium vessels 1 and 3, reducing total boil-off. Because the outer shield 8 experiences the largest radiation load, it is common for it to have supplementary cooling from liquid nitrogen boiling at atmospheric pressure (77K) in a vessel 8a thermally connected to the shield 8. The entire vessel assembly is enclosed in an evacuated vessel 9 to reduce conduction and convection loss. The magnet and inner vessels are typically suspended using a web of fibreglass rods (not shown) to reduce conduction heat load. A bore tube (not shown) at room temperature and pressure passes through the assembly and through the magnet bore to allow samples to be placed inside the magnet.

After passing through the pump 13 the helium gas is either conventionally vented to atmosphere and lost, collected for later re-use (after re-liquefaction in a separate plant), or recycled into the cryostat.

In the event of a superconducting magnet quench (a failure of superconducting state and release of stored magnetic energy as heat), a spring-closed pop-off valve 14 allows the boiling helium in the first vessel 1 to escape to the second vessel 3, and hence to atmosphere, before a dangerous over-pressure condition develops. The very small gaps around the mechanical pop-off valve 14 (which cannot be avoided in practice) would represent a significant superleak path if the liquid in the first vessel were to become superfluid. As explained above, this is avoided by operation above 2.17K.

A major disadvantage of known systems is the large quantity of stored helium. When the magnet 2 quenches this is lost to atmosphere. It is possible to capture some helium gas in factory-based storage balloons for later re-liquefaction, but this is expensive and bulky and not practical in commercial end-user systems. Helium is also becoming increasingly rare in a readily obtainable form and therefore its cost is increasing. It is therefore highly desirable to reduce the amount of helium used in such apparatus, or indeed that lost in a quench.

In accordance with a first aspect of the present invention, we provide magnet apparatus comprising:—

a magnet chamber;

a magnet positioned within the magnet chamber; and

a quantity of superfluid coolant which partially fills the magnet chamber such that at least part of the magnet is cooled by a film of the superfluid coolant.

We have realised that the superfluid properties of a coolant such as helium-4 (⁴He) can be used to dramatically reduce the amount of helium needed to cool a magnet. A second major advantage of this is that, during a quench of a superconducting magnet in which the coolant is totally vaporised, the provision of a small amount of coolant results in a much smaller volume of coolant gas which, if contained in a chamber, will result in a much lower gas pressure.

The use of a dramatically reduced volume of coolant is achieved by cooling the magnet with a superfluid film of helium, that is below T_{λ}, ideally at ˜1.7-2.1K (to maximise the heat capacity). As previously described, in prior art systems operating above T_{λ} (˜2.2K) the magnet must be completely sub-merged in coolant liquid to minimise temperature gradients in the magnet structure. This requires a large volume of liquid, typically several hundred litres for a high field magnet. In contrast for a comparable system with the present invention, the quantity of superfluid coolant liquid is about 1 to 10% of this volume. The superfluid helium film coats the entire magnet surfaces above the liquid helium pool in a “Rollin film” about 20 nanometres thick. The enormous thermal conductivity of a superfluid, and high velocity of film propagation, ensures that the temperature variation over the magnet will be very small.

Unlike in known systems, typically the magnet and the quantity of superfluid coolant are arranged such that the magnet is only partially immersed in a pool of the superfluid coolant within the chamber. Due to the zero viscosity properties of the superfluid, the magnet may actually not be immersed in the pool of superfluid coolant at all although, in this case, the film will nevertheless pass over the surfaces of the magnet, joints, switches and other accessories and provide the cooling effect using for example the surfaces of the magnet support structures (such as fibre-glass rods) as conduits.

Although in some cases it is envisaged that the apparatus may be used without any additional systems for cooling the coolant, preferably, the magnetic apparatus further comprises a refrigeration system for maintaining at least some of the coolant as a superfluid within the chamber. This provides for the use of the magnet over extended periods.

Not only does the invention allow a very small quantity of coolant to be used, the volume of such a coolant then being typically much less than that of the magnet chamber, but also it is possible for substantially all of the coolant to be retained within the magnet chamber in the event of a magnet quench or when the chamber is raised to ambient temperature. This has not been possible before and allows the coolant to be reused in both factory environments and at end-user premises.

In cases where the coolant is not fully retained within the magnet chamber itself, preferably the apparatus further comprises a supply chamber which is adapted in use to contain a reservoir of the coolant. The coolant in the supply chamber is in its non-superfluid phase. A first conduit is then provided which connects the interiors of the supply and magnetic chambers so as to allow the supply of the coolant from the supply chamber to the magnet chamber. This allows the replenishment of magnet coolant due to losses resulting from heating. The first conduit may open into the magnet chamber at a position within the superfluid pool itself.

Typically an expansion valve or other device to effect a pressure difference within the first conduit is provided so as to allow the coolant to cool below the lambda point upon passing through the valve.

Preferably the apparatus further comprises a second conduit that passes from the interior of the magnet chamber to a location external to the apparatus. In some cases the second conduit opens into the magnet chamber. A pump is typically provided so as to lower the pressure within the second conduit. If the second conduit is arranged to have one end which is open to the gas within the magnet chamber, then the pressure reduction caused by the pump will also reduce the pressure within the magnet chamber thereby causing the further cooling of the coolant by lowering its boiling point.

The gaseous coolant which is removed through the second conduit by the pump may be used to pre-cool the coolant passing along the first conduit, in which case preferably a first heat exchanger is provided for thermally coupling the first and second conduits.

In an alternative example, the first and second conduits are joined such that they form a common conduit in the magnet chamber and therefore the action of the pump in the second conduit causes cooling of the coolant from the supply chamber below the lambda point. In this case, the coolant passes from the supply chamber through the first and second conduit (common) to the pump and cooling of the magnet chamber is effected by the presence of the common conduit being at a temperature beneath the lambda point. Preferably in this case a second heat exchanger is positioned within the common conduit, thermally coupling the common conduit (containing the coolant from the supply chamber) with the coolant gas in the interior of the magnet chamber.

The common conduit and second heat exchanger may be arranged within the magnet chamber such that gaseous coolant within the chamber condenses upon the second heat exchanger and drops under gravity onto the magnet itself. This effectively causes the precipitation of superfluid coolant onto the magnet surface.

The common conduit need not be physically positioned within the magnet chamber itself. It may be positioned at a location in good thermal contact with one or more of the magnet chamber walls, for example externally, or even formed as part of these walls. Cooling of the magnet chamber in this case occurs by thermal conduction. A common conduit having parts both external and internal to the chamber is also envisaged.

In some examples, the common conduit can form part of a closed-loop cooling system, preferably containing helium-3 as a coolant. Here the coolant downstream of the pump is returned to the first conduit via heat exchangers. The first conduit is therefore no longer open to the supply chamber although the supply chamber may be used to pre-cool the helium-3 coolant. Alternatively, when no supply chamber is used, a mechanical refrigerator can provide this function.

The magnet apparatus may be contained within a liquid nitrogen containing vessel forming part of a cryostat. Typically a number of radiation shields are provided so as to further insulate the magnet chamber from the external environment. In this case, one or more further heat exchangers may be positioned within the second conduit to cool the respective radiation shields. The operational pressure within the magnet chamber during use is below atmospheric pressure.

Although the supply chamber may be positioned above the magnet chamber, it may also take the form of a jacket which at least partially surrounds the magnet chamber. This provides for a reduction in the total height of the apparatus, and also acts to insulate the magnet chamber further from the external environment.

The magnet chamber may also be sealed and isolated from the supply chamber in arrangements where the coolant from the supply chamber is not used to replenish that within the magnet chamber. In this case the magnet chamber can be charged with gaseous coolant whilst at ambient temperature or with gaseous or liquid coolant when at a lower temperature.

Unlike in prior art systems, a sealed magnet chamber may be used safely with the present invention since the magnet chamber may be arranged in accordance with the volume of superfluid coolant, such that even upon the complete conversion of the coolant into gaseous form, the pressure within the chamber may not reach a catastrophic level.

Although the unoccupied volume of the magnet chamber will vary depending upon the application in question, this may be in excess of 100 litres, whereas the volume of superfluid coolant (in liquid form) may be less than 10% or even less than 1% of this volume.

The use of a superfluid coolant requires consideration of potential “superleak” problems. In apparatus where it is desired to fit a “safety valve” feature such that the Pressure within the magnet chamber cannot rise beyond a predetermined limit, then preferably a “burst disc” valve is used. This has a single use operation and therefore is replaced if an unexpectedly high pressure causes operation of the burst disc.

It will also be appreciated that preferably the magnet is a superconducting magnet although again in principle other magnets could be used, the advantage with superconducting magnets being that they provide the strongest magnetic fields and in persistent mode, the heat output is almost zero.

In accordance with a second aspect of the present invention we provide a method of cooling a magnet positioned within a magnet chamber comprising partially filling the magnet chamber with a quantity of superfluid coolant such that at least part of the magnet is cooled by a film of the superfluid coolant.

The method according to the second aspect of the invention can therefore be used with suitable apparatus, such as that provided by the first aspect of the invention. The magnet can therefore be either partially immersed in a pool of the superfluid or not immersed in the pool, the superfluid providing the cooling nevertheless due to its zero viscosity.

In most cases the method further comprises using a refrigeration system to maintain a quantity of the coolant as a superfluid within the magnet chamber.

The method may further comprise supplying further coolant to the magnet chamber from a supply chamber, and in this case, the supply chamber may contain coolant in a non-superfluid phase wherein, during its supply to the magnet chamber, the coolant is cooled to the superfluid phase by reducing the pressure of the magnet chamber with respect to the supply chamber. This may be achieved using a pump.

In the event of an increase, in the pressure within the magnet chamber, the method preferably further comprises operating the pump so as to reduce the pressure build-up. The magnet chamber may also be cooled by a method in which coolant is passed along the conduit from the supply chamber, the conduit passing through the magnet chamber and/or through a location in good thermal contact with the magnet chamber, to an external location so as to pass the coolant through the conduit and thereby cool the magnet chamber. Typically the coolant within the conduit is cooled to a desired temperature by the use of an evaporation cooling process.

The conduit may also form part of a closed-loop cooling system in which helium-3 is pumped to maintain the superfluid helium-4 in the magnet chamber at the operational temperature. The helium-4 in the supply chamber or a mechanical refrigerator can be used to provide some pre-cooling in this case.

The method may therefore further comprise the use of a heat exchanger in the conduit to increase the thermal coupling between the conduit and the helium vapour within the magnet chamber. This may be positioned so as to precipitate condensed gas onto the magnet.

The method also preferably comprises initially supplying the quantity of superfluid coolant to the magnet chamber.

Although the method and apparatus of the present invention may be used in conventional end-user operations such as in performing experiments in an industrial context, the method and apparatus may also be used prior to the supply of the apparatus to an eventual customer, or in preparation for such operations each of these involving superconducting magnet ‘training’.

Therefore in accordance with a third aspect of the present invention, a method of training a superconducting magnet is provided wherein the magnet is positioned within a magnet chamber, the method comprising:—

a) partially filling the magnet chamber with a quantity of coolant capable of forming a superfluid;

b) cooling the magnet using a method according to the second aspect of the invention;

c) energising the magnet until the magnet quenches; and,

d) repeating steps (b) and (c) until the magnet operates according to predetermined operational parameters.

The training of a superconducting magnet is an important procedure in the initial setup of superconducting magnet apparatus. This may be performed at one or each of the supplier and customer premises and involves the repeated energisation of the superconducting magnet until reliable operation (without quench) can be produced. Such reliable operation can be quantified as operational parameters in terms of operating current and run-time.

Some examples of magnetic apparatus and methods according to the present invention will now be described, with reference to the accompanying drawings in which:—

FIG. 1 shows the specific heat capacity of helium-4 in the region of the lambda point;

FIG. 2 is a schematic illustration of a prior art system for cryogenically cooling a magnet;

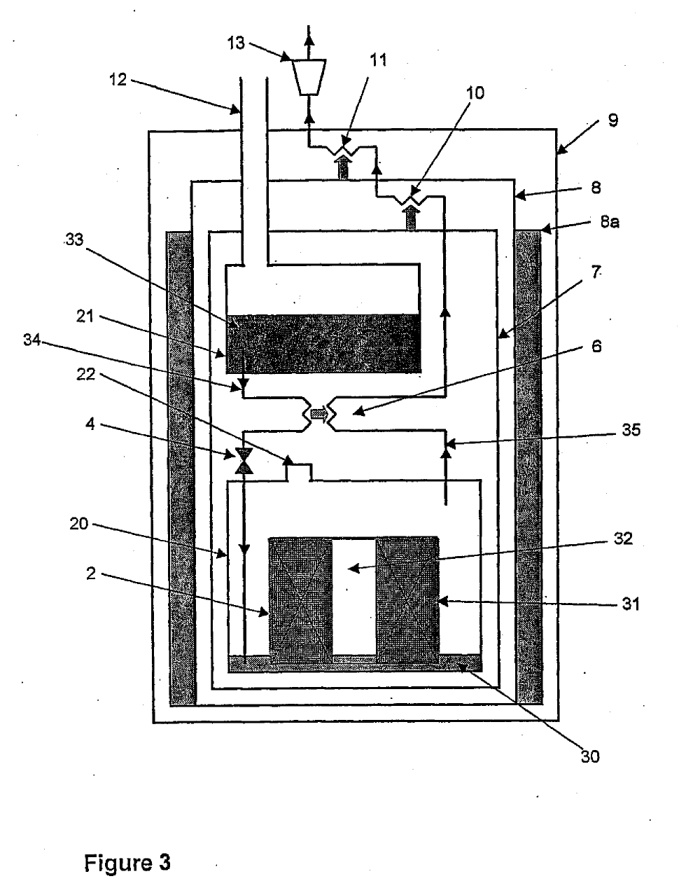

FIG. 3 shows a schematic illustration of apparatus according to a first example of the invention;

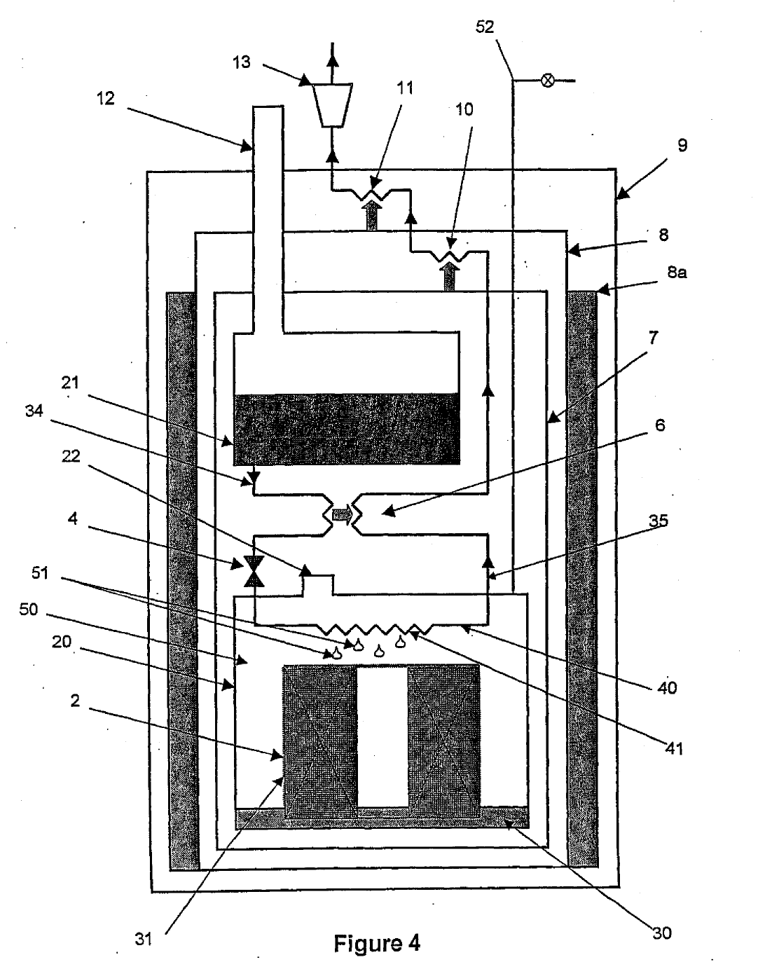

FIG. 4 shows a second example apparatus according to the invention;

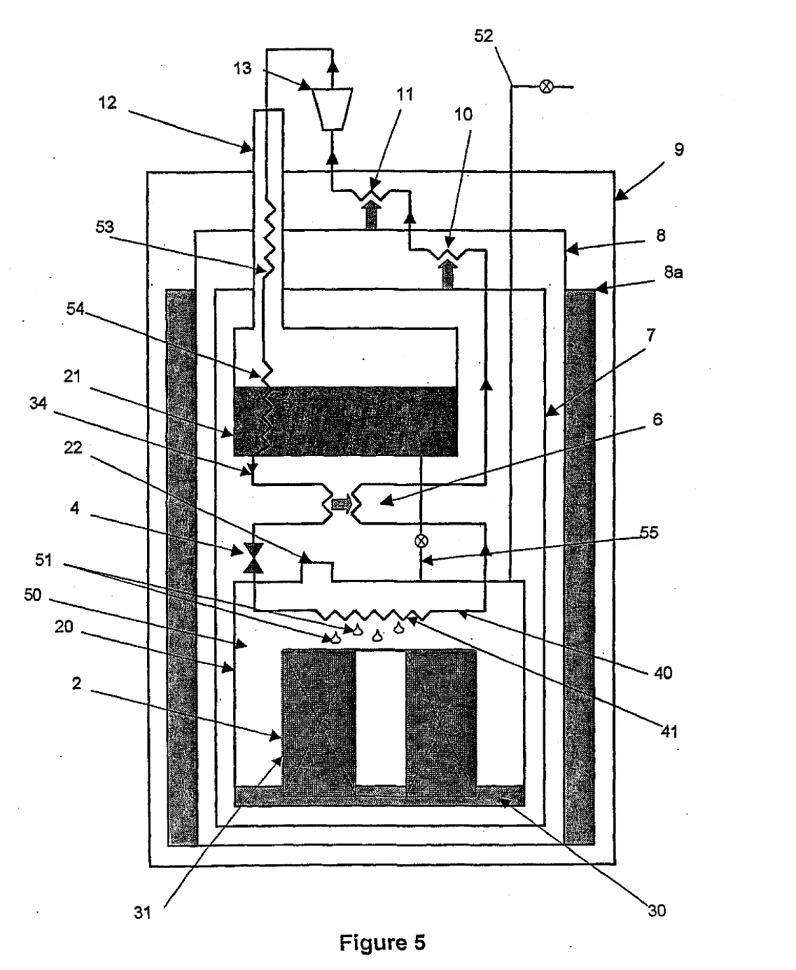

FIG. 5 shows a third example apparatus according to the invention; and,

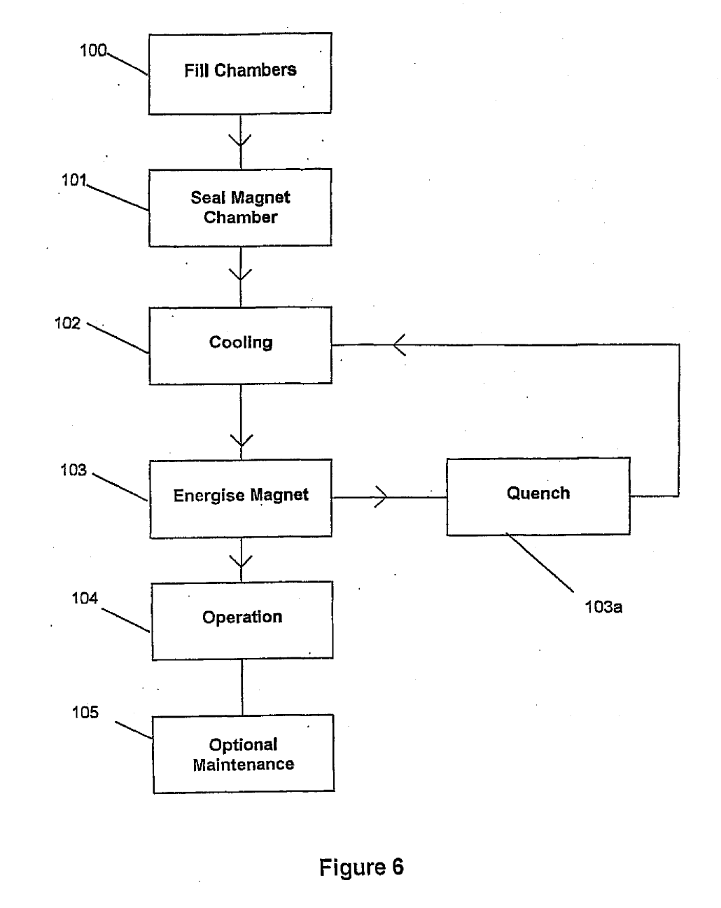

FIG. 6 shows a method of using the apparatus according to either of the first, second or third examples.

FIG. 3 shows a first example of magnetic apparatus according to the present invention. In comparison with the apparatus of FIG. 2, elements having substantially similar functions are denoted with similar reference numerals within FIG. 3. FIG. 3 therefore illustrates a cryostat containing a vacuum chamber within which a liquid nitrogen vessel is provided together with radiation shields so as to insulate the inner chambers from the external environment.

In contrast to the prior art system of FIG. 2 in the present example, a magnet vessel 20 is provided within which is positioned the superconducting magnet 2 to be cooled. Within the bottom of the magnet chamber 20 a pool 30 of helium-4 is provided, this being a superfluid at a temperature below the lambda point. As is indicated schematically in FIG. 3, the volume of the pool 30 is much less than the internal volume of the magnet chamber 20. The superfluid properties of the helium-4 coolant cause a thin Rollin film of superfluid to coat all of the connected internal surfaces of the chamber 20, these importantly including the magnet 2. This film is illustrated at 31. The magnet 2 contains a central bore 32 within which experimental apparatus is located when in use.

A supply chamber 21 is positioned above the magnet chamber 20 and, in contrast to the prior art system of FIG. 2, it will be noted that the chambers 20 and 21 are isolated from each other. The supply chamber 21 contains a reservoir of helium-4 33, this being at substantially a temperature of 4.2 Kelvin (since the chamber 21 is at atmospheric pressure when in use).

A conduit 34 (first conduit) connects the interior of the supply chamber 21 to that of the magnet chamber 20. The first conduit being fitted with an expansion valve 4. The lower end of the first conduit opens into the pool of superfluid coolant 30. In another part of the magnet chamber 20, a second conduit, having an end open to the gas within the magnet chamber 20, is provided, this passing from the magnet chamber 20 through the various chamber walls and radiation shields of the cryostat to an external location where a pump 13 is positioned to extract gas from the chamber 20 via the second conduit. The cold coolant gas exiting the magnet 20 via the second conduit 35 passes through a heat exchanger 6 which pre-cools the coolant within the conduit 34, and then via additional heat exchangers 10 and 11 so as to cool the radiation shield of the cryostat.

When in operation, the pump 13 is operated so as to draw coolant gas out of the magnet chamber 20. The resultant reduction in pressure within the magnet chamber 20 ensures that the superfluid pool 30 is kept beneath the lambda point temperature. The lower pressure draws further coolant from the supply chamber 21 via the conduit 34. This coolant passes through the expansion valve 4 which allows a constant flow of sub-cooled helium to enter the magnet vessel. The flow impedance of the valve 4 allows a pressure differential to exist across the valve 4 such that the coolant passing through the valve undergoes partial evaporation and therefore cooling, through the lambda point, such that when it arrives at the pool 30 of coolant at the bottom of the magnet chamber 20, it is at the desired temperature.

The superfluid film 31 provides cooling via two mechanisms. The first is conductive in the sense that heat is transferred through the superfluid film coating the magnet 2. The second mechanism is by evaporation of the film at hotspots. This transfers heat by latent heat of evaporation and replacement of the evaporated film by superfluid flowing to the warmer hotspot regions.

When the superconducting magnet 2 is operating in persistent mode, it generates negligible heating itself but nevertheless must be cooled due to other heating influences. The majority of the heat load on the magnet chamber 20 is therefore by conduction and radiation from the external environment.

It will be noted that the open end of the second conduit 35 in the magnet chamber provides a liquid leak path for the superfluid due to its zero viscosity. The leak flow of superfluid film is minimised by providing the conduit 35 with an internal circumferential lip having a highly sharpened edge.

FIG. 3 also illustrates that the magnet chamber 20 contains a burst disc 22. It should be noted that this is not a mechanical quench valve since, unlike such a valve, the burst disc provides a solution to the superleak problem. In the event of a superconductor quench within the magnet, with the use of a suitable amount of superfluid helium-4, the magnet chamber 20 and burst disc 22 are designed to withstand the transient pressure pulse generated as the few litres of helium-4 vaporise. The use of the pump 13 and conduit 35 ensure that the over-pressure is relieved within a few seconds. Note that a “pop-off” valve (not shown) is fitted to protect the pump from the raised pressure. The burst disc 22 should therefore only fail in the unlikely event that the magnet 2 quenches when there is too much coolant or contamination in the magnet vessel 20. In this case the burst disc would have to be replaced. Although the burst disc 22 is shown in an upper wall of the chamber 20, it is not necessary for it to be positioned at this location. It can be placed anywhere in the chamber wall and indeed it may be positioned within a lower wall of the chamber so as to allow ease of access for replacement or maintenance.

A second example of apparatus according to the invention is shown in FIG. 4. Components with similar reference numerals denote similar apparatus when compared with the first example. In this case, it will be noted that the first conduit 34 and the second conduit 35 are joined together in the upper part of the magnet chamber 20 to form a common conduit 40. The first conduit part therefore enters the magnet chamber 20 and passes above the magnet 2 as the common conduit 40, then exiting the chamber as the second conduit 35. At a position in the common conduit 40 above the magnet 2, a heat exchanger 41 is located. It will be noted that the common conduit 40 and heat exchanger 41 are downstream of the valve 4. The common conduit is therefore cooled to a temperature beneath the lambda point. The heat exchanger 41 as generally surrounded by saturated helium-4 gas as is illustrated at 50.

Due to the low temperature of the common conduit 40 and heat exchanger 41, the gas 50 condenses upon the heat exchanger 41 and then falls under gravity onto the upper surface of the magnet 2 so as to cool it. This is shown at 51. This example therefore differs from the first example in that the coolant within the first, second and common conduits remains isolated from the coolant 30 within the chamber. In this case therefore, the magnet chamber 20 can be sealed completely (after being filled with a predetermined amount of coolant) so as to conserve helium-4 coolant. Filling can be achieved using a filling line 52 with associated valve. Again a burst disc 22 is provided in the unlikely event of a magnet quench when there is too much coolant or contamination in the magnet chamber 20.

It will be appreciated that the common conduit need not pass physically through the magnet chamber 20 itself. It may be positioned so that it is in good thermal contact with the chamber 20 interior such that the desired cooling effect is achieved. This can be effected by placing the common conduit adjacent the magnet chamber wall(s) or forming it as part of the wall(s).

FIG. 5 shows a third example system which is a modification of the second example. In this case, the cooling system containing the conduits 34, 35, 40, together with the heat exchangers and pump 13 is modified to become a closed circuit in which the coolant contained therein is re-used. Rather than venting from the pump as in the second example (FIG. 4), in this example a further conduit is provided downstream of the pump to redirect the helium back down the tube 12, through the supply chamber 21 and then to the first conduit 34. Two heat exchangers 53 and 54 are placed in series in the additional part of the circuit, the first additional heat exchanger 53 being positioned within the tube 12 comprising the neck of the supply chamber 21. The second additional heat exchanger 54 is positioned within the supply chamber 21 itself. In this case, helium-3 is used as the coolant since this provides a higher vapour pressure which in turn allows for more efficient cooling with respect to helium-4. However, it should be noted that helium-4 could also be used within the closed circuit.

The cooling mechanism within the parts of the circuit which are similar to the second example (FIG. 4) occurs in the same manner as in that example. The helium-3 exiting the pump 13, does so at approximately ambient temperature and then this is redirected down the tube 12 where it is cooled in the heat exchanger 53 by helium-4 which is evaporating from the supply chamber 21. The heat exchanger 54 ensures that this helium attains a temperature of 4.2 Kelvin, that is similar to the temperature of the helium-4 within the bath 21 as it passes through the heat exchanger 54. The helium-3 then passes down the first conduit 34 and through the expansion valve 4 so as to reach the required sub-cooled temperature which causes precipitation of helium-4 vapour within the magnet chamber 20.

The supply chamber 21 therefore has a different function within the present example, namely in that its primary function is to cool the helium-3 via the heat exchanger 54.

Although the magnet chamber 20 is sealed in operation, a filling line 55 including a valve may be provided between the supply chamber 21 and magnet chamber 20 so as to allow the magnet chamber to be filled to a desired level with liquid helium-4. An alternative or additional filling line 52 may be provided as also illustrated in FIG. 5, this providing helium-4 gas from a supply external to the cryostat, the line 52 also opening into the magnet chamber 20 so as to allow it to be filled with the required amount of helium-4 gas.

As a further modification upon the third example of FIG. 51 the supply chamber 21 may be dispensed with and replaced by a suitable mechanical refrigeration device such as a pulse tube refrigerator (PTR), the function of this being to provide the cooling of the helium-3 by heat exchangers 53 and 54. In a two stage PTR, the first stage could be used to cool the heat exchanger 53, and the second lower temperature stage could be used to cool the second heat exchanger 54. The line 55 would therefore also be absent from such a modified system, although the line 52 could be used to fill the magnet chamber 20 with the required amount of helium-4.

As in the case of the conduit 35 in FIG. 3, each of the lines 55 and 52 may be provided with internal sharpened circumferential edges so as to reduce the amount of helium-4 super-leakage.

FIG. 6 illustrates an example method of using the apparatus according to the invention, such as is described above in association with FIG. 3, 4 or 5. In an initial step 100, the chambers 20 and 21 are filled with respective predetermined amounts of liquid or gaseous helium. The magnet chamber 20 is then sealed at step 101.

At step 102 the pump 13 is then operated so as to begin the cooling of the magnet chamber 20. In the first example, this involves a reduction in the pressure within the chamber 20 and the drawing of helium-4 through the expansion valve 4 so as to cool it to superfluid temperatures. The magnet chamber 20 therefore begins to be cooled below the lambda point.

In the second and third examples, cooling occurs by the effect of the heat exchanger 41 and conduit 40, each of which are cooled due to the expansion valve 4 and pump 13, and the resultant effect upon the coolant as it passes through the valve 4. This cooling continues until a stable operational temperature is attained. In each case the operational temperature of the superfluid is between 1.7 and 2.1 Kelvin.

If the volume of helium-4 coolant within the supply chamber 21 becomes too small, then this can be topped up via the tube 12. At step 103, the magnet 2 is energised to a predetermined current level. This can therefore be used in a subsequent step 104 in desired magnetic procedures such as NMR experiments. Step 105 represents a relatively rare maintenance step in which the magnet is de-energised, the pump 13 is switched off and the magnet chamber 20 is vented as it is brought up to ambient temperature and pressure. The helium within the magnet chamber 20 can be collected, as can that within the supply chamber 21, for later re-use.

When the apparatus is used in the performance of training of the superconducting magnet 2, then a modified method is used as is also illustrated in FIG. 6. In this case, the magnet 2 undergoes repeated energisation and quenching, this quenching is caused by energy dissipation from minor movements within the magnet coils and the formation of cracks within the material supporting the coils, this typically being epoxy resin. The training of the magnet therefore typically involves a gradual ramping of the current supplied to the coils of the superconducting magnet 2. This is shown at 103 and 103a where a quench occurs following an earlier energisation of the magnet. Since quenching causes heating of the magnet then the magnet is recooled at step 102 prior to re-energisation. This process is repeated using increasing currents (ramped from a zero current) until the magnet 2 can reliably operate at the desired current level (step 104).

As will be appreciated, the training of a superconducting magnet may be used following initial manufacture, for example at the factory, but also once the magnet system is installed at an end-user location due to disturbances caused by transport of the apparatus.

1. Magnet apparatus comprising:
a magnet chamber;
a magnet positioned within the magnet chamber; and
a quantity of superfluid coolant which partially fills the magnet chamber such that at least part of the magnet is cooled by a superfluid film of the coolant.

2. Magnet apparatus according to claim 1, wherein the magnet and the quantity of superfluid coolant are arranged such that the magnet is partially immersed in a pool of the superfluid coolant within the chamber.

3. Magnet apparatus according to claim 1, wherein the magnet and the quantity of superfluid coolant are arranged such that in use, the superfluid forms a pool in the magnet chamber and wherein the magnet is not immersed in the pool.

4. Magnet apparatus according to claim 1, further comprising a refrigeration system for maintaining at least some of the coolant as a superfluid within the chamber.

5. Magnet apparatus according to claim 1, wherein the magnet chamber and the quantity of superfluid coolant are arranged such that substantially all of the coolant can be retained within the chamber if the temperature in the chamber is raised to ambient temperature.

6. Magnet apparatus according to claim 1, further comprising a first conduit which passes into the magnet chamber or to a location in good thermal contact with the magnet chamber, and is adapted to contain coolant so as to cool the magnet chamber.

7. Magnet apparatus according to claim 6, further comprising a supply chamber adapted in use to contain a reservoir of the coolant in a non-superfluid phase, the first conduit connecting the interiors of the supply and magnet chambers so as to allow the supply of the coolant from the supply chamber to the magnet chamber.

8. Magnet apparatus according to claim 6, wherein an expansion valve is located in the first conduit.

9. Magnet apparatus according to claim 6, further comprising a second conduit passing from the interior of the magnet chamber or from a location in good thermal contact with the magnet chamber, to a location external to the apparatus.

10. Magnet apparatus according to claim 9, further comprising a pump for lowering the pressure within the second conduit.

11. Magnet apparatus according to claim 9, further comprising a first heat exchanger for thermally coupling the first and second conduits.

12. Magnet apparatus according to claim 9, wherein the first and second conduits are joined as a common conduit within the magnet chamber or at a location in good thermal contact with the magnet chamber.

13. Magnet apparatus according to claim 12, further comprising a second heat exchanger positioned within the common conduit for thermally coupling the common conduit with gaseous coolant within the magnet chamber.

14. Magnet apparatus according to claim 13, wherein the second heat exchanger is located above the magnet, such that gaseous coolant condensed by the second heat exchanger falls under gravity onto the magnet.

15. Magnet apparatus according to claim 9, wherein one end of the second conduit is open to the coolant gas within the magnet chamber when in use.

16. Magnet apparatus according to claim 9, further comprising one or more further heat exchangers and corresponding radiation shields for thermally coupling the second conduit with the radiation shields.

17. Magnet apparatus according to claim 7, wherein the supply chamber is operated in use at atmospheric pressure.

18. Magnet apparatus according to claim 7, wherein the supply chamber is arranged as a jacket at least partially surrounding the magnet chamber.

19. Magnet apparatus according to claim 1, wherein the magnet chamber is a sealed chamber.

20. Magnet apparatus according to claim 1, wherein the internal volume of the magnet chamber is in excess of 100 liters.

21. Magnet apparatus according to claim 1, further comprising a pressure release valve fitted to the magnet chamber.

22. Magnet apparatus according to claim 21, wherein the valve is a burst disc valve.

23. Magnet apparatus according to claim 1, wherein the superfluid coolant is helium-4.

24. Magnet apparatus according to claim 1, wherein the magnet is a superconducting magnet.

25. Magnet apparatus according to claim 1, wherein the magnet chamber and the quantity of superfluid coolant are arranged such that substantially all of the coolant can be retained within the chamber in the event that the magnet quenches during use.

26. Magnet apparatus according to claim 1, the apparatus being arranged such that the operational pressure of the magnet chamber is below atmospheric pressure.

27. Magnet apparatus according to claim 12, wherein the first, second and common conduits form part of a closed loop refrigeration system containing a further coolant.

28. Magnet apparatus according to claim 27, wherein the further coolant is pre-cooled using a mechanical refrigerator.

29. Magnet apparatus according to claim 27, wherein the further coolant is pre-cooled using the coolant with the supply chamber.

30. Magnet apparatus according to claim 29, wherein a heat exchanger is provided in thermal contact with gaseous coolant from the supply chamber reservoir.

31. Magnet apparatus according to claim 29, therein a heat exchanger is provided in thermal contact with the liquid coolant in the supply chamber.

32. Magnet apparatus according to claim 1, further comprising a supply line for filling the magnet chamber with helium-4.

33. A method of cooling a magnet positioned within a magnet chamber, comprising partially filling the magnet chamber with a quantity of superfluid coolant such that at least part of the magnet is cooled by a film of the superfluid coolant.

34. A method according to claim 33, wherein the magnet is partially immersed in a pool of the superfluid coolant within the magnet chamber.

35. A method according to claim 33, wherein the superfluid coolant forms a pool within the chamber and wherein the magnet is not immersed in the pool.

36. A method according to claim 33, further comprising maintaining at least some of the coolant as a superfluid within the magnet chamber, using a refrigeration system.

37. A method according to claim 33, further comprising, supplying further coolant to the magnet chamber from a supply chamber.

38. A method according to claim 37, wherein the coolant in the supply chamber is retained in a non-superfluid phase, and wherein during its supply to the magnet chamber the coolant is cooled to the superfluid phase by reducing the pressure in the magnet chamber with respect to the supply chamber.

39. A method according to claim 38, wherein the pressure is reduced using a pump.

40. A method according to claim 39, wherein, in the event of a temperature rise within the magnet chamber causing an increase in pressure, the method further comprises operating the pump so as to reduce the pressure.

41. A method according to claim 33, further comprising providing a supply chamber containing a coolant and a conduit passing through the magnet chamber or through a location in good thermal contact with the magnet chamber, to an external location, passing the coolant from the supply chamber through the conduit so as to cool the magnet chamber.

42. A method according to claim 41, wherein the pressure in the conduit is lowered with respect to the supply chamber so as to reduce the temperature of the coolant flowing within the conduit.

43. A method according to claim 42, wherein the coolant in the supply chamber is similar to that within the magnet chamber and wherein the coolant within the supply chamber is in a non-superfluid phase and is cooled into the superfluid phase.

44. A method according to claim 33, wherein the magnet chamber is cooled by a closed loop system comprising the conduit and which passes through the magnet chamber or through a location in good thermal contact with the magnet chamber.

45. A method according to claim 44, wherein the closed loop system contains a quantity of helium-3.

46. A method according to claim 41, wherein the magnet chamber is cooled using a heat exchanger positioned in the conduit.

47. A method according to claim 46, wherein the heat exchanger cools the magnet chamber by condensing gaseous coolant within the magnet chamber.

48. A method according to claim 47, wherein the heat exchanger is positioned above the magnet such that the gaseous coolant falls by the action of gravity, onto the magnet.

49. A method according to claim 33, further comprising, initially supplying the quantity of superfluid coolant to the magnet chamber.

50. A method according to claim 33, wherein the superfluid coolant is helium-4.

51. A method according to claim 50, wherein the superfluid coolant is at a temperature of 1.7 to 2.1 Kelvin.

52. A method of training a superconducting magnet positioned within a magnet chamber, the method comprising:
a) partially filling the magnet chamber with a quantity of coolant capable of forming a superfluid;
b) cooling the magnet using a method according to claim 33;
c) energizing the magnet until the magnet quenches; and
d) repeating steps (b) and (c) until the magnet operates according to predetermined operational parameters.
